(19) United States
(12) Patent Application Publication
(10) Pub. No.: US 2025/0151675 A1
(43) Pub. Date: May 15, 2025

(54) User-Portable Blower and/or Vacuum Device

(71) Applicant: Andreas Stihl AG & Co. KG, Waiblingen (DE)

(72) Inventor: Markus PFEIFER, Winnenden (DE)

(21) Appl. No.: 18/941,881

(22) Filed: Nov. 8, 2024

(30) Foreign Application Priority Data
Nov. 10, 2023 (DE) 10 2023 131 346.0

(51) Int. Cl. A01G 20/47

(52) U.S. Cl. CPC A01G 20/47

(57) ABSTRACT

A user-portable blower and/or vacuum device, in particular a leaf blower and/or vacuum device, includes: a blowing and/or suctioning tube for conveying a blowing and/or suctioning air flow along a tube axis of the blowing and/or suctioning tube, a fan unit for generating the blowing and/or suctioning air flow conveyable through the blowing and/or suctioning tube, a housing which carries the blowing and/or suctioning tube and which has a handle and two side sections, wherein the handle extends at least partially within a reference plane of the blower and/or vacuum device containing the tube axis, wherein the reference plane runs between the two side sections, and a first fastening device arranged on one of the side sections, and a second fastening device arranged on the same side section and at a distance from the first fastening device along the tube axis.

### CROSS REFERENCE TO RELATED APPLICATION

This application claims priority under 35 U.S.C. § 119 from German Patent Application No. 102023131346.0, filed Nov. 10, 2023, the entire disclosure of which is herein expressly incorporated by reference.

### BACKGROUND AND SUMMARY

The invention relates to a user-portable blower and/or vacuum device, in particular a leaf blower and/or vacuum device.

It is an object of the present invention to provide a user-portable blower and/or vacuum device, in particular in the form of a leaf blower and/or vacuum device, which has improved properties.

This object is achieved by the subject matter of the independent claim. Preferred embodiments are the subject matter of the dependent claims.

A user-portable blower and/or vacuum device according to the invention has a blowing and/or suctioning tube for conveying a blowing and/or suctioning air flow along a tube axis of the blowing and/or suctioning tube. In the present context, “along” can be understood synonymously to “parallel”. In particular, the blowing and/or suctioning tube extends lengthwise along the tube axis. The user-portable blower and/or vacuum device can be a leaf blower and/or vacuum device.

The user-portable blower and/or vacuum device has a fan unit for generating the blowing and/or suctioning air flow, which can be conveyed through the blowing and/or suctioning tube. The user-portable blower and/or vacuum device also has a housing. The housing carries the blowing and/or suctioning tube. In particular, the housing also carries the fan unit. The housing has a handle, in particular an integral handle. Moreover, the housing has two, in particular external, side sections. The handle extends, in particular at least or only partially, within a reference plane of the blower and/or vacuum device that includes the tube axis. The reference plane can contain the tube axis. The reference plane runs between the side sections. In particular, the tube axis and a direction of longitudinal extent of the handle span the reference plane. This means that the side sections can flank the reference plane. The handle extends in particular along its direction of longitudinal extent. In particular, the two side sections can transition into each other transverse to the tube axis, in particular exactly opposite the handle, in particular in the reference plane.

The user-portable blower and/or vacuum device further comprises a first fastening device, in particular in the form of a first carrying eyelet, and a second fastening device, in particular in the form of a second carrying eyelet. The first fastening device and the second fastening device are arranged on the same side section of the housing. In this case, the first fastening device and the second fastening device, in particular as viewed perpendicular to the tube axis, are arranged at a distance from each other along the tube axis. In particular, the distance between the fastening devices extends and/or is measured only along the tube axis, it being possible for the fastening devices to be at different distances from the reference plane. In other words: The first fastening device is arranged on one of the side sections, and the second fastening device is arranged on the same relevant side section at a distance from the first fastening device along the tube axis. In particular, the blower and/or vacuum device can be carried by the user jointly by means of the first fastening device and by means of the second fastening device. By means of the two fastening devices, a carrying force allowing the user to carry the blower and/or vacuum device can be introduced into the housing. By means of the two fastening devices, the carrying force can advantageously be introduced in each case proportionally at different points of the housing. Accordingly, it is possible to design each of the fastening devices to transfer only a portion of the carrying force. In particular, the amount of carrying force corresponds to the weight of the user-portable blower and/or vacuum device. By virtue of the fact that the fastening devices are arranged at a distance from each other along the tube axis, a clearance can advantageously be made available between the two fastening devices, which clearance can be used, for example, for a user hand gripping the handle. Since the two fastening devices are arranged laterally on the housing next to the handle, the blower and/or vacuum device carried by the user can automatically align itself by gravity so that the handle is inclined away from the user. This can facilitate gripping by the user.

In particular, the user-portable blower and/or vacuum device is only in a user-borne state when the blower and/or vacuum device is actually being carried by a user. By contrast, the blower and/or vacuum device is in particular only user-portable, and not (yet) in a user-borne state, as long as it is set up to be carried by the user but is currently not (yet) being carried by the user. In particular, the reference plane is inclined relative to a direction of gravity when the blower and/or vacuum device is in the user-borne state.

In one embodiment of the invention, the handle is arranged along the tube axis between the first fastening device and the second fastening device. In particular, the first fastening device and—alternatively or additionally—the second fastening device is located in the region of a transition between the respective side section and the handle of the housing. The handle can thus advantageously be arranged in a region adjacent to the clearance between the two fastening devices, so that the handle can be gripped, in particular without obstacle, through the clearance by means of the user hand.

In a further embodiment of the invention, the first fastening device and the housing are designed and/or connected to each other as one part or as two parts. Alternatively or additionally, the second fastening device and the housing are designed and/or connected to each other as one part or as two parts. The one-part connection can advantageously render complex mounting of the respective fastening device onto the housing obsolete. By contrast, the two-part connection of the respective fastening device to the housing can allow interchangeability of the respective fastening device, especially in the event of damage. If the respective fastening device is connected to the housing as one part, the respective fastening device can be integrally moulded on the housing. If the respective fastening device is connected to the housing as two parts, the respective fastening device can be screwed onto the housing.

In a further embodiment of the invention, the housing is formed in several parts. The first fastening device and the second fastening device are arranged either on a common housing part of the housing or on different housing parts of the housing.

In a further embodiment of the invention, the housing has an air-permeable ventilation grille housing part. In this case, the fan unit, in particular along the tube axis, is arranged between the ventilation grille housing part and the blowing and/or suctioning tube in order to convey air for the blowing and/or suctioning air flow through the ventilation grille housing part. The first fastening device is arranged, in particular integrally moulded, on the ventilation grille housing part.

In a further embodiment of the invention, the fan unit is electrically driven in order to generate the blowing and/or suctioning air flow.

In a further embodiment of the invention, the user-portable blower and/or vacuum device has an exchangeable electric battery pack, carried by the housing, for supplying the fan unit with electrical drive energy. The battery pack can be an electric battery pack. The battery pack is arranged, in particular accommodated, opposite the handle and at a distance from the tube axis. This can result in particularly advantageous positioning of an overall center of mass of the user-portable blower and/or vacuum device.

In a further embodiment of the invention, the user-portable blower and/or vacuum device has a strap element. The strap element has a first strap end and a second strap end. The first strap end can lie opposite the second strap end, particularly along the tube axis. In this case, the first strap end is coupled to the first fastening device and the second strap end is coupled to the second fastening device, in particular releasably.

In a further embodiment of the invention, the strap element has a connecting device which, in particular along the tube axis, is arranged between the first strap end and the second strap end. The connecting device can be arranged centrally or off-center between the two strap ends of the strap element. The strap element can be elastically extensible in length at least in part and/or substantially non-elastically extensible in length. A position of the connecting device between the two strap ends can be adjustable and lockable, in particular so as to set an inclination of the tube axis of the user-borne blower and/or vacuum device relative to a direction of gravity. Alternatively or additionally, at least one strap section of the strap element present between one of the two strap ends and the connecting device can be made variable in length, i.e. in particular with a length adjustable free of longitudinal extension. Alternatively or additionally, at least one or exactly one of the strap sections can be designed to be elastically extensible in length. The connecting device is designed for connecting the strap element to a user-borne or user-portable carrying device, in particular in the form of a carrying strap. In particular, the carrying device is not a component part of the user-portable blower and/or vacuum device. In particular, the connecting device has a strap loop for attachment of a hook of the carrying device. When the user-portable blower and/or vacuum device is carried by the user by means of the user-borne carrying device, the connecting device of the belt element can be arranged, with respect to the direction of gravity, in particular substantially precisely above the overall center of mass of the user-portable blower and/or vacuum device.

In a further embodiment of the invention, the overall center of mass of the user-portable blower and/or vacuum device is arranged, along the tube axis, between the first fastening device and the second fastening device. Alternatively or additionally, the first fastening device and the second fastening device are each arranged perpendicular to the tube axis with respect to the direction of gravity above the overall center of mass of the user-portable blower and/or vacuum device when the user-portable blower and/or vacuum device is carried by the user jointly by means of the first fastening device and by means of the second fastening device. This promotes the aforementioned gravity-induced automatic alignment of the user-borne blower and/or vacuum device.

Further advantages and features of the invention will become clear from the claims and from the following description of preferred exemplary embodiments of the invention, which are illustrated in the drawings. The same reference signs denote the same or similar or functionally identical components.

It will be appreciated that the aforementioned features and the features still to be explained below can be used not only in the respectively cited combination, but also in other combinations or singly, without departing from the scope of the present invention.

### BRIEF DESCRIPTION OF THE DRAWINGS

FIG. 1 is a schematic side view of an embodiment of a user-portable blower and/or vacuum device according to the invention;

FIG. 2 shows the user-borne, user-portable blower and/or vacuum device according to FIG. 1 in a schematic perspective view; and

FIG. 3 shows the user-portable blower and/or vacuum device according to FIGS. 1 and 2 in a plan view.

### DETAILED DESCRIPTION OF THE DRAWINGS

A user-portable blower and/or vacuum device 1, which in the present case is designed as a leaf blower and/or vacuum device 2, has a blowing and/or suctioning tube 3. The blowing and/or suctioning tube 3 serves to convey a blowing and/or suctioning air flow along a tube axis A of the blowing and/or suctioning tube 3. The blower and/or vacuum device 1 also has a fan unit 4. The fan unit 4 serves to generate the blowing and/or suctioning air flow conveyable through the blowing and/or suctioning tube 3. In addition, the blower and/or vacuum device 1 has a housing 5. The housing 5 carries the blowing and/or suctioning tube 3 and, in the present case, the fan unit 4. The housing 5 has a handle 6. The housing 5 also has two side sections 7.

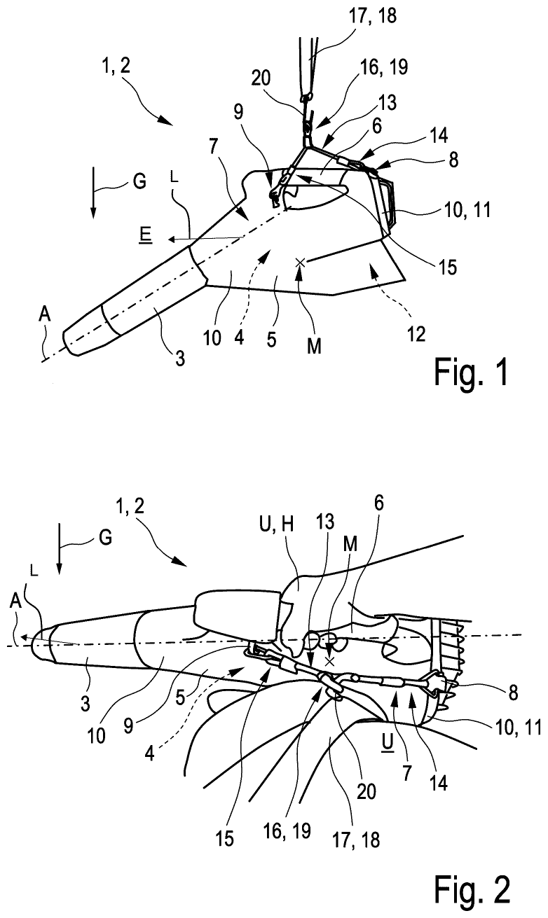

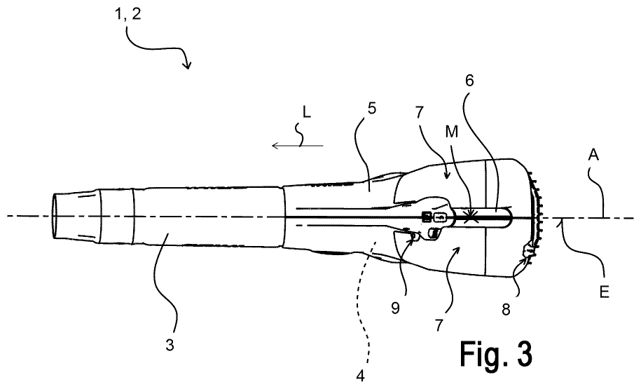

The handle 6 extends lengthwise within a reference plane E of the blower and/or vacuum device 1. The reference plane E contains the tube axis A. The reference plane E runs between the two side sections 7. In this case, the tube axis A and a direction of longitudinal extent L of the handle 6 span the reference plane E. In the illustration in FIG. 1, the blower and/or vacuum device 1 is shown perpendicular to the reference plane E. The drawing plane of the illustration in FIG. 1 is correspondingly parallel to the reference plane E. The drawing plane of the illustration in FIG. 3 is perpendicular to the reference plane E.

The blower and/or vacuum device 1 has a first fastening device 8 and a second fastening device 9. The first fastening device 8 is arranged on one of the side sections 7, wherein the second fastening device 9 is arranged on the same side section 7 as the first fastening device 8. The first fastening device 8 and the second fastening device 9 are here arranged at a distance from each other along the tube axis A. In the present case, the blower and/or vacuum device 1 is user-portable by means of the first fastening device 8 and by means of the second fastening device 9 jointly.

According to FIG. 2, the user-portable blower and/or vacuum device 1 is carried by a user U. FIG. 2 thus shows the user-borne, user-portable blower and/or vacuum device 1. The user U has a user hand H. In this case, the handle 6 according to FIG. 2 is gripped by the user hand H. The blower and/or vacuum device 1 is carried by the user, according to FIG. 2, jointly by means of the first fastening device 8 and by means of the second fastening device 9. In particular, the blower and/or vacuum device 1 according to FIG. 2 is not carried by means of the user hand H, and instead the user hand H serves only to orient the blowing and/or suctioning tube 3 relative to a ground surface which is to be at least partially freed of leaves and other types of dirt by means of the blower and/or vacuum device 1 designed as a leaf blower and/or vacuum device 2.

For example, the handle 6 is arranged along the tube axis A between the first fastening device 8 and the second fastening device 9. In particular, this does not presuppose that the handle 6 is arranged in common alignment with the first fastening device 8 and—alternatively or additionally—the second fastening device 9.

The first fastening device 8 and the housing 5 can be connected to each other as two parts or—as in the present case—as one part. Alternatively or additionally, the second fastening device 9 and the housing 5 can be connected to each other as two parts or—as in the present case—as one part. For example, the housing 5 is formed in several parts. The first fastening device 8 and the second mounting device 9 can be arranged on a common housing part 10 of the housing 5 or—as in the present case—on different housing parts 10 of the housing 5.

The housing 5 has, for example, an air-permeable ventilation grille housing part 11. In this case, the fan unit 4 is arranged between the ventilation grille housing part 11 and the blowing and/or suctioning tube 3 in order to convey air for the blowing and/or suctioning air flow through the ventilation grille housing part 11. In the present case, the fan unit 4 is arranged along the tube axis A between the ventilation grille housing part 11 and the blowing and/or suctioning tube 3. The first fastening device 8—as in the present case—can be arranged on the ventilation grille housing part 11. For example, the first fastening device 8 is integrally moulded on the ventilation grille housing part 11.

The fan unit 4 of the blower and/or vacuum device 1 is, for example, electrically driven to generate the blowing and/or suctioning air flow. The user-portable blower and/or vacuum device 1 can, for example, have an exchangeable electric battery pack 12, carried by the housing 5, for supplying the fan unit 4 with electrical drive energy. The battery pack 12 is designed in the present case as a rechargeable battery pack. The battery pack 12 can be arranged, in particular accommodated, opposite the handle 6 and at a distance from the tube axis A.

The user-portable blower and/or vacuum device 1 has, for example, a strap element 13. The strap element 13 in the present case has a first strap end 14 and a second strap end 15. In this case, the first strap end 14 is coupled to the first fastening device 8, for example releasably. The second strap end 15 is coupled to the second fastening device 9, for example releasably. The strap ends 14, 15 can be arranged opposite each other, in particular along the tube axis A.

The strap element 13 can—as in the present case—have a connecting device 16 which is arranged between the first strap end 14 and the second strap end 15. For example, the connecting device 16 is arranged along the tube axis A between the strap ends 14, 15. The connecting device 16 is designed for connecting the strap element 13 to a user-portable carrying device 17 which, according to FIG. 2, is carried by the user. The carrying device 17 can be in the form of a carrying strap 18. In particular, the carrying device 17 is not a component part of the user-portable blower and/or vacuum device 1. The connecting device 16 has a belt loop 19 in the present case. The belt loop 19 can be configured for attachment of a hook 20 of the carrying device 17. Alternatively or additionally, the connecting device 16 can have a ring, for example a metal ring, for attachment of the hook 20.

The connecting device 16 can be arranged centrally between the strap ends 14, 15 or off-center. The strap element 13 can be elastically longitudinally extensible at least in some areas. A position of the connecting device 16 relative to the strap ends 14, 15 can be adjustable and lockable. In the present case, the position of the connecting device 16 relative to the strap ends 14, 15 is not adjustable. Alternatively or additionally, at least one of two strap sections of the strap element 13 that are present between one of the two strap ends 14, 15 and the connecting device 16 can be designed to be variable in length, i.e. in particular with a length adjustable free of longitudinal extension. Alternatively or additionally, at least one or exactly one of the strap sections can be designed to be elastically extensible in length.

In the present case, the user-portable blower and/or vacuum device 1 has an overall center of mass M. This overall center of mass M is arranged, for example, along the tube axis A between the first fastening device 8 and the second fastening device 9. Alternatively or additionally, the first fastening device 8 and the second fastening device 9—as in the present case—are each arranged perpendicular to the tube axis A with respect to a direction of gravity G above the overall center of mass M of the user-portable blower and/or vacuum device 1 when the user-portable blower and/or vacuum device 1—as in FIG. 2—is carried by the user jointly by means of the first fastening device 8 and by means of the second fastening device 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A user-portable blower and/or vacuum device, comprising:
a blowing and/or suctioning tube for conveying a blowing and/or suctioning air flow along a tube axis of the blowing and/or suctioning tube;
a fan for generating the blowing and/or suctioning air flow conveyable through the blowing and/or suctioning tube;
a housing which carries the blowing and/or suctioning tube and which has a handle and two side sections, wherein the handle extends within a reference plane of the blower and/or vacuum device containing the tube axis, wherein the reference plane runs between the two side sections; and
a first fastening device arranged on one of the two side sections, and a second fastening device arranged on the same side section and at a distance from the first fastening device along the tube axis.

2. The user-portable blower and/or vacuum device according to claim 1, wherein
the handle is arranged along the tube axis between the first fastening device and the second fastening device.

3. The user-portable blower and/or vacuum device according to claim 1, wherein
the first fastening device and the housing are connected to each other as one part or as two parts, and/or
the second fastening device and the housing are connected to each other as one part or as two parts.

4. The user-portable blower and/or vacuum device according to claim 1, wherein
the housing is formed in several parts, and
the first fastening device and the second fastening device are arranged on a common housing part of the housing or on different housing parts of the housing.

5. The user-portable blower and/or vacuum device according to claim 1, wherein
the housing has an air-permeable ventilation grille housing part,
the fan is arranged between the ventilation grille housing part and the blowing and/or suctioning tube in order to convey air for the blowing and/or suctioning air flow through the ventilation grille housing part, and
the first fastening device is arranged on the ventilation grille housing part, in particular moulded integrally thereon.

6. The user-portable blower and/or vacuum device according to claim 5, wherein
the first fastening device is molded integrally on the ventilation grille housing part.

7. The user-portable blower and/or vacuum device according to claim 1, wherein
the fan is electrically driven to generate the blowing and/or suctioning air flow.

8. The user-portable blower and/or vacuum device according to claim 7, wherein
the user-portable blower and/or vacuum device has an exchangeable electric battery pack, carried by the housing, for supplying the fan with electrical drive energy, and
the battery pack is arranged opposite the handle and at a distance from the tube axis.

9. The user-portable blower and/or vacuum device according to claim 1, wherein
the user-portable blower and/or vacuum device has a strap element,
the strap element has a first strap end and a second strap end opposite the first strap end, and
the first strap end is coupled to the first fastening device and the second strap end is coupled to the second fastening device.

10. The user-portable blower and/or vacuum device according to claim 9, wherein
the strap element has a connecting device which is arranged between the first strap end and the second strap end,
the connecting device is configured for connecting the strap element to a user-borne or user-portable carrying device in the form of a carrying strap, and
the connecting device has a strap loop and/or a ring for attachment of a hook of the carrying device.

11. The user-portable blower and/or vacuum device according to claim 1, wherein
an overall center of mass of the user-portable blower and/or vacuum device is arranged along the tube axis between the first fastening device and the second fastening device, and/or
the first fastening device and the second fastening device are each arranged perpendicular to the tube axis with respect to a direction of gravity above the overall center of mass of the user-portable blower and/or vacuum device when the user-portable blower and/or vacuum device is carried by the user jointly via the first fastening device and the second fastening device.

12. The user-portable blower and/or vacuum device according to claim 1, wherein
the device is a leaf blower and/or a vacuum device.
